(19) United States
(12) Patent Application Publication
(10) Pub. No.: US 2006/0040546 A1
(43) Pub. Date: Feb. 23, 2006

(54) Performance indicating electrical connector

(75) Inventors: Paul A. Werthman, Canterbury, NH (US); Gary E. Schrader, Manchester, NH (US); Peter A. Waltz, Bristol, NH (US); Michael Rzasa, Nashua, NH (US)

Correspondence Address: HARRINGTON & SMITH, LLP, 4 RESEARCH DRIVE, SHELTON, CT, 06484-6212, US

(73) Assignee: FCI Americas Technology, Inc.

(21) Appl. No.: 11/170,468

(22) Filed: Jun. 28, 2005

Related U.S. Application Data
(60) Provisional application No. 60/591,307, filed on Jul. 26, 2004.

(51) Int. Cl. H01R 3/00

(52) U.S. Cl. 439/488

(57) ABSTRACT

In accordance with one aspect of the present invention, an electrical connector is provided including a main section and a connector performance indicating section connected to a portion of the main section. The main section includes a first connection section adapted to connect to a first electrical conductor and a second connection section adapted to connect to a second electrical conductor. The main section is adapted to electrical connect the first electrical conductor to the second electrical conductor. The connector performance indicating section includes a temperature sensitive chemical indicator adapted to signal and permanently record a temperature of the portion of the main section above a predetermined temperature.

### CROSS REFERENCE TO RELATED APPLICATION

This application claims priority under 35 U.S.C. §119(e) on provisional patent application No. 60/591,307 filed Jul. 26, 2004 which is hereby incorporated by reference in its entirety.

### BACKGROUND OF THE INVENTION

1. Field of the Invention

The present invention relates to electrical connectors and, more particularly, to a performance indicating section on an electrical connector.

2. Brief Description of Prior Developments

Electrical connectors are subjected to electrical loads. As current passes through a conductor it sees resistance and generates heat. It is common practice to measure connector performance by tracking temperature. In a laboratory environment this is usually done with a thermocouple. In the field, electrical power connectors are sometimes checked using infra-red thermal imaging devices.

Phase change temperature indicating labels and paints are known. They provide the feature of a permanent color change when a specified temperature is exceeded. For example, Lakfabriek Korthals BV, of Ijmuiden, The Netherlands sells Therm-O-Signal™ coatings which, by a perceptible change in color, indicate that a pre-selected temperature has been reached or exceeded. Telatemp Corporation of Fullerton, Calif. sells irreversible temperature labels which contain one or more sealed temperature sensitive chemical indicators which sense and record surface temperatures.

Ferraz Shawmut sells AMP-TRAP 2000® fuses which are type-2 no-damage fuses for circuit protection, and are available in five classes: Class J/AJT, Class L/A4BQ, Class RK1/A2D, A6D, Class CC/ATDR and ATQR. The fuses can open in less than ¼ cycles under short circuit conditions. The fuses limit enough current to prevent down streak damage. SMART SPOT™ open fuse indicators have been added to the line of AMP-TRAP 2000® fuses. With SMART SPOT™, a colored piece of MYLAR is covered with a sacrificial metal foil. When current flows through the foil, the foil evaporates and the colored MYLAR section is revealed. When the Ferraz Shawmut AMP-TRAP 2000® fuse opens, SMART SPOT™ immediately surges and turns from silver to red. The SMART SPOT™ remains red to facilitate proper capable out.

There is a desire to provide a connector design providing direct performance feedback for field application and maintenance.

### SUMMARY OF THE INVENTION

In accordance with one aspect of the present invention, an electrical connector is provided comprising a main section and a connector performance indicating section connected to a portion of the main section. The main section comprises a first connection section adapted to connect to a first electrical conductor and a second connection section adapted to connect to a second electrical conductor. The main section is adapted to electrically connect the first electrical conductor to the second electrical conductor. The connector performance indicating section comprises a temperature sensitive chemical indicator adapted to signal and permanently record a temperature of the portion of the main section above a predetermined temperature.

In accordance with another aspect of the present invention, an electrical connector is provided comprising a compressible connection section which is sized and shaped to be compressed onto an electrical conductor; and a visual indicium temperature sensitive indicator thermally coupled to the compressible connection section. The temperature sensitive indicator is adapted to signal and permanently record occurrence of a temperature at the temperature sensitive indicator above a predetermined temperature.

In accordance with another aspect of the present invention, an electrical connector is provided comprising a compressible connection section which is sized and shaped to be compressed onto an electrical conductor; and a non-electrical temperature sensitive indicator thermally coupled to the compressible connection section. The temperature sensitive indicator is adapted to signal and permanently record occurrence of a temperature at the temperature sensitive indicator above a predetermined temperature.

In accordance with one method of the present invention, a method of manufacturing an electrical connector is provided comprising providing an electrical connector member; and thermally coupling a temperature sensitive indicator to the electrical connector member. The temperature sensitive indicator is adapted to permanently signal, by visual indicium, occurrence of a temperature at the temperature sensitive indicator above a predetermined temperature.

### BRIEF DESCRIPTION OF THE DRAWINGS

The foregoing aspects and other features of the present invention are explained in the following description, taken in connection with the accompanying drawings, wherein:

FIG. 1 is a block diagram of a connector system having an electrical connector incorporating features of the present invention;

FIG. 2 is a block diagram of the electrical connector shown in FIG. 1 showing the connector performance indicating section;

FIG. 3 is a perspective view of one embodiment of the electrical connector shown in FIG. 2;

FIG. 4 is a perspective view of the electrical connector shown in FIG. 3 after being subjected to a temperature above a predetermined temperature;

FIGS. 5-15 are perspective views of alternate embodiments of various types of compression electrical connector incorporating features of the present invention;

FIG. 16 is a partial cross sectional view showing use of a heat shield with a connector incorporating features of the present invention;

FIG. 17 is a plan view showing use of the present invention on a label and having an indicium which appears upon occurrence of an over-temperature condition;

FIGS. 18 and 19 are partial cross sectional views of an alternate embodiment of the present invention using a flowable marker material;

FIGS. 20 and 21 are perspective views of another alternate embodiment of the present invention using a shape memory allow material as a connector performance indicating section;

FIG. 22 is a perspective view of an alternate embodiment of the present invention which uses a Radio-Frequency Identification (RFID) tag attached to the connector

FIG. 23 is a top plan view of another embodiment of the invention; and

FIG. 24 is a top plan view of another embodiment of the invention.

### DETAILED DESCRIPTION OF THE PREFERRED EMBODIMENTS

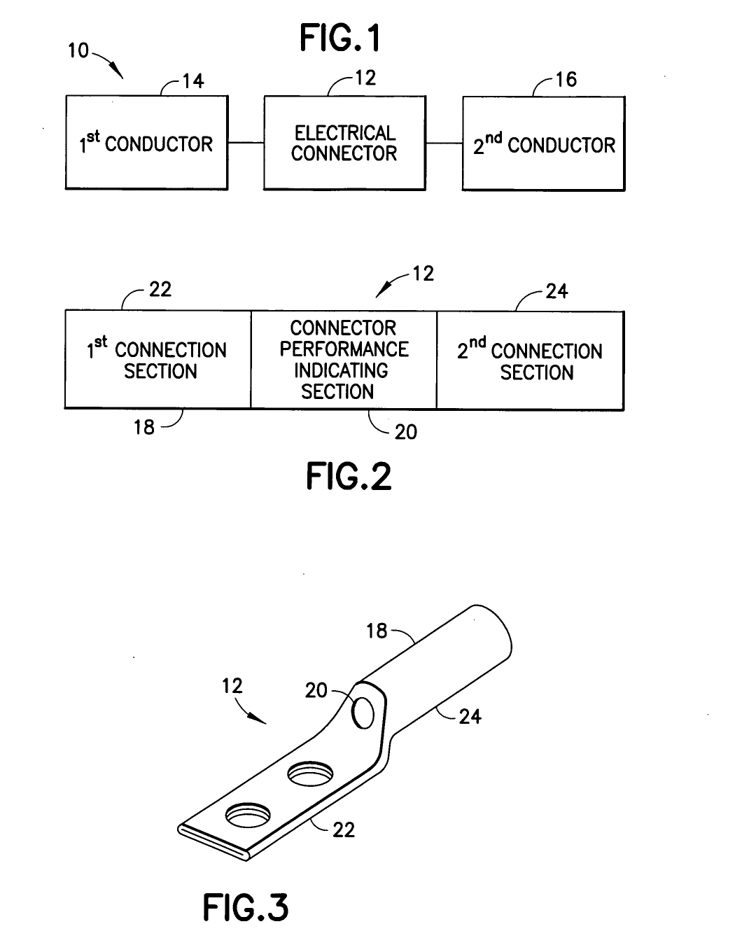

Referring to FIG. 1, there is shown a block diagram of a connector system 10 having an electrical connector 12 incorporating features of the present invention. Although the present invention will be described with reference to the exemplary embodiments shown in the drawings, it should be understood that the present invention can be embodied in many alternate forms of embodiments. In addition, any suitable size, shape or type of elements or materials could be used.

The electrical connector 12 is adapted to electrically connect a first electrical conductor 14 with a second electrical conductor 16. Referring also to FIG. 2, the electrical connector 12 generally comprises a main section 18 and a connector performance indicating section 20 connected to the main section. The main section 18 comprises a first connection section 22 and a second connection section 24. In an alternate embodiment the main section could comprise more than two connection sections. The main section 18 could comprise any suitable shape. The main section 18 could also be comprised of a one-piece member or a multi-piece member(s). The first connection section 22 is adapted to electrically and mechanically connect to the first conductor 14. The second connection section 24 is adapted to electrically and mechanically connect to the second conductor 16. The first connection section 22 and/or the second connection section 24 could comprise any suitable type of connection sections including, for example, compression sections, press-fit sections, fastener receiving sections, etc.

The connector performance indicating section 20 is connected to the main section in any suitable fashion. For example, the connector performance indicating section 20 could be painted onto the main section 18, or attached to the main section such as by adhesive or epoxy, or retained to the main section by a fastener, or retained by a deformed portion of the main section, or received in a slot shaped receiving section of the main section 18. The connector performance indicating section 20 preferably comprises a temperature sensitive chemical indicator or phase change temperature indicator adapted to signal and permanently record a temperature of a portion of the main section above a predetermined temperature.

The connector performance indicating section 20 could comprise a phase change temperature indicating sticker, label or paint providing the feature of a permanent color change when a specified temperature is exceeded. For example, a coating which, by a perceptible change in color indicate that a pre-selected temperature has been reached or exceeded, such as Therm-O-Signal™ sold by Lakfabriek Korthals BV, of Ijmuiden, The Netherlands could be used as the connector performance indicating section 20. As another example, the connector performance indicating section 20 could be an irreversible temperature label which contains one or more sealed temperature sensitive chemical indicators which sense and record surface temperatures, such as sold by Telatemp Corporation of Fullerton, Calif. In alternate embodiments, any suitable type of temperature sensitive connector performance indicating section could be provided on the electrical connector 12.

This invention provides a connector design with a direct performance feedback for field application and maintenance. The phase change temperature indicating material could be directly applied to the electrical connector during manufacture. If the connector exceeds an allowable application temperature during service, the color on the exterior of the connector can change. This can provide direct feedback that a maintenance issue exists.

There are at least two primary applications of the present invention. The first application is for power connectors. As described above any power connector exceeding an application temperature would have its indicator change color permanently. This permanent color change provides an advantage versus infra-red thermal imaging devices that only show temperature at a given point in time. With an infra-red thermal imaging device, if the circuit being measured is not currently under an electrical load the infra-red thermal imaging will not detect a high resistance joint. With the present invention, on the other hand, the connector performance indicating section 20 will record an excess temperature which can be read at a later time after the excess heat occurs.

A second application exists for grounding connectors. In this case a connector may not see a fault current for a long period of time. However, when a fault does occur, and is of a sufficiently large magnitude, the connector can experience damage reducing future performance and safety. If the phase change material is used with a grounding connector, it will have the ability to show that a fault current was experienced as indicated by color change. A field maintenance person can then have the opportunity to inspect the connector and other surrounding equipment for possible damage and take corrective action. Of course, the present invention could be used in applications other than power and ground applications.

The following illustrations are offered to show one way the phase change material may be observed on a compression connector. Many variations of connectors and locations for the phase change material can be considered. Referring to FIG. 3 one embodiment of the electrical connector 12 is shown with a main section 18, a first connection section 22 and a second connection section 24. The connector performance indicating section 20 is painted onto the main section 18 as a dot and has a general silver color. In an alternate embodiment, the connector performance indicating section 20 could have any suitable shape and any suitable natural color. The first connection section 22 comprises a fastener connection section which is adapted to receive fasteners (not shown) to attach the first connection section to the first conductor. The second connection section 24 comprises a tube shaped section which is adapted to receive an end of the second conductor and be crimped or compressed onto the second conductor.

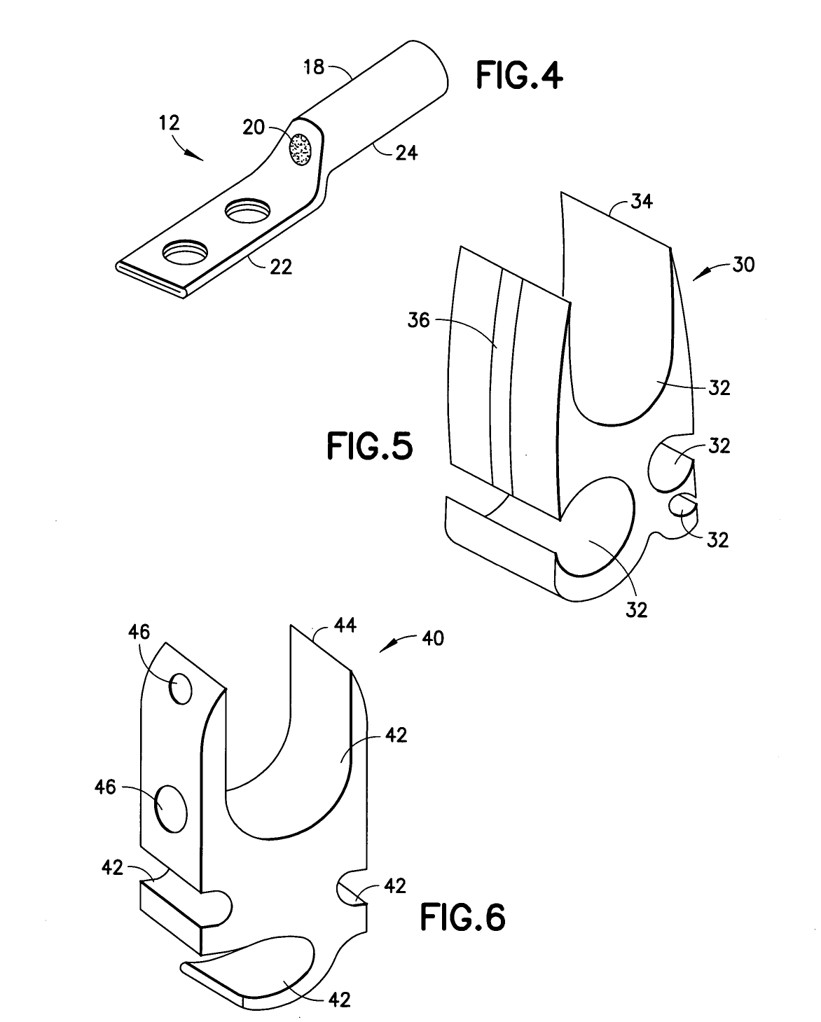

Referring now to FIG. 4, the electrical connector 12 of FIG. 3 is shown after the connector has been subjected to heat above a predetermined temperature. The color of the connector performance indicating section 20 has changed from silver to black. This provides a simple and easy to identify indication that the connector 12 has been subjected to a temperature above the predetermined temperature. This can signal or indicate that the connection with the first or second conductors by the electrical connector is having, or has had, a connector performance issue. This provides a performance feedback for the electrical connector and can signal maintenance issues with the electrical connector or the joints with the first or second electrical conductors. The color indicating an over-temperature condition could be a color other than black. For example, the color could be blue, grey, orange, white, green, etc. In an alternate embodiment, the connector performance indicating section 20 could change to any suitable natural color or signaling pattern or indicium. In one type of embodiment, the paint starts as red, and changes to black at about 65° C.

It is important to note that the design concept of performance feedback electrical connectors can be expanded to other methods beyond phase change paints. Radio frequency devices and other feedback systems may be researched in conjunction with this project.

The present invention could be combined with thermal shielding of the temperature sensitive indicator material. The thermal shielding could shield the temperature sensitive indicator material from sources of heat that are not generated by a corresponding electrical connector. For example, one instance is where the exterior of an electrical connector could be subjected to direct sunlight, and the heat/UV radiation could give a false indication of failure; even though the metal core has not been heated to an unacceptable heat level. As another example, the electrical connector could be located close to a heat source, such as a furnace or burner. As another example, if the connector is side-by-side with another connector, the heating of one connector could cause the external temperature sensitive indicator material on the other connector to turn color. One possible shielding is a transparent UV or heat resistant coating over the exterior surface of the temperature sensitive indicator material. The temperature sensitive indicator material could be insulated on the external side, but not the side adjacent to the connector itself. A cowl or hood could serve the same purpose.

The present invention could also be used by mixing a temperature sensitive indicator material, or even a non-temperature sensitive indicator material which is merely colored, with a melt material that melts at a predetermined temperature. The melt material, such as paraffin or solder or plastic, could be positioned inside of an electrical connector. If the conductive portion of the connector reaches the melting point of the melt material, the material could melt and pour out of a hole in the electrical connector or coating of the electrical connector. If provided as a paint, the paint could make the material visible for inspection purposes. The temperature sensitive indicator material or colored marker could be encapsulated by the melt material, which could subsequently rupture upon excessive heat above a predetermined temperature, or could be mixed with the melt material, etc.

A printed indicium could be provided on the connector, such as a warning label attached to the connector for example or permanent ink printed on the connector, which is covered by a cover layer made of a low melting point material, such as 120 degree semi-refined paraffin wax or an element such as Indium. The cover could melt and flow off of the printed indicium to thereby expose the indicium. This could warn that the connector has been exposed to a predetermined over-temperature condition. This can provide a permanent indication when conditions are met. This can also provide a means of reapplying the covering in the field if the cause of the indication is reasoned not to be the connection or an over-temperature condition.

The present invention can provide a compressible electrical connector that carries a performance indicator. A compressible electrical connector is different from circuit breakers and fuses. In the past, it was not obvious to apply a performance indicator to a compressible connector before the connector is crimped because the crimping operation can adversely affect the mechanical attachment of the performance indicator to the connector. The compressible connectors are stamped with various numbers and symbols. However, the indicia stamped on the connectors can smear or distort after the crimp is made. Therefore, was not obvious not include a performance indicator on a compressible connector because it did not make sense, prior to the present invention, to add a component (and cost) that one skilled in the art would have known would be mangled during the crimping process. However, it has been discovered that enough of the performance indicator can remain on the connector after the crimping operation to provide a visual indication.

In one type of alternate embodiment, the connector member having the indicator could be an electrical contact terminal which is part of an electronic device, or located on a housing of an electrical connector. The outer surface of the connector can define a dimple or recessed area that can receive the performance indicator. This can help with any surface wiping problems. Applying paint to the conductor receiving sides of a compressible connector might not be commercially viable, because the insulation of the mating wires could obscure the sides of the connector from view. This could defeat the purpose of the visual indicator. However, in some embodiments, placement of the material on the mating sides of the connector could be used.

A heat indication sticker that is attached to the connector before or after the crimp could also be used. These types of stickers are already commercially available. Temperature indicating paint could also be applied to the connector before or after crimping. Other optional features include a UV protective layer over the paint/sticker and/or a colored material that changes phase when exposed to heat. For example, solid to liquid, and if it cools down again, the shape of the re-solidified material would be different. Multiple indicators can also be used on a single connector. For example, each could be activated by a particular temperature range, i.e. 60-65 C, 65-70 C, etc.

Referring also to FIG. 5, an alternate embodiment of the present invention is shown. In this embodiment an electrical compression connector 30 is provided which has multiple conductor receiving channels 32. A similar electrical connector is described in U.S. Pat. No. 5,200,576 which is hereby incorporated by reference in its entirety. The connector 30 has a frame 34 made of metal and a connector performance indicating section 36. The connector performance indicating section 36 can comprise a paint strip or a sticker or label as described above. The connector performance indicating section 36 can turn color when exposed to a predetermined temperature. In this embodiment, the connector performance indicating section 36 is located along at least a portion of the compressible or crimped portion of the connector frame 34.

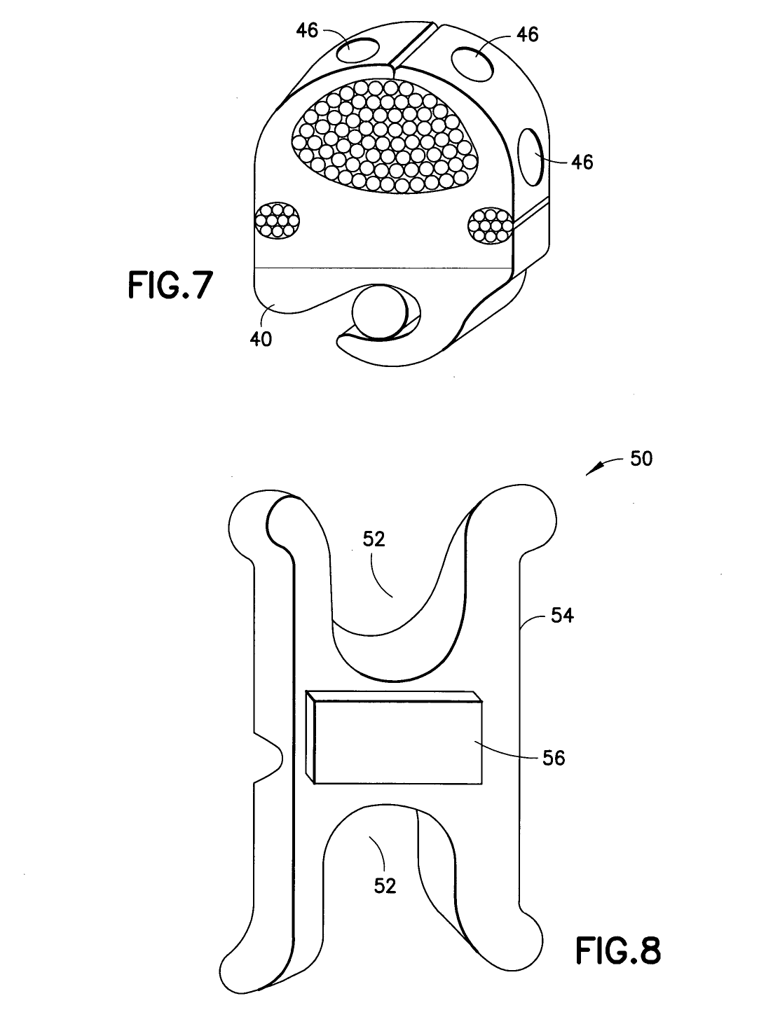

Referring also to FIGS. 6 and 7, another alternate embodiment is shown. In this embodiment an electrical compression connector 40 is provided which has multiple conductor receiving channels 42. A similar electrical connector is described in U.S. Pat. No. 5,200,576. The connector 40 has a frame 44 made of metal and multiple connector performance indicating sections 46. The connector performance indicating sections 46 can comprise paint strips or stickers or labels as described above. The connector performance indicating sections 46 can turn color when exposed to a predetermined temperature. In this embodiment, the connector performance indicating sections 46 are located at compressible or crimped portions of the connector frame 44 as well as non-crimped portions.

Referring also to FIG. 8, an alternate embodiment of the present invention is shown. In this embodiment an electrical compression connector 50 is provided which has multiple conductor receiving channels 52. A similar electrical connector is described in U.S. Pat. No. 5,552,564 which is hereby incorporated by reference in its entirety. The connector 50 has a frame 54 made of metal and a connector performance indicating section 56. The frame has a general H shape. The connector performance indicating section 56 can comprise a paint strip or a sticker or label as described above. In this embodiment the section 56 is a label which is attached to the frame by thermally conductive adhesive. The connector performance indicating section 56 can turn color when exposed to a predetermined temperature.

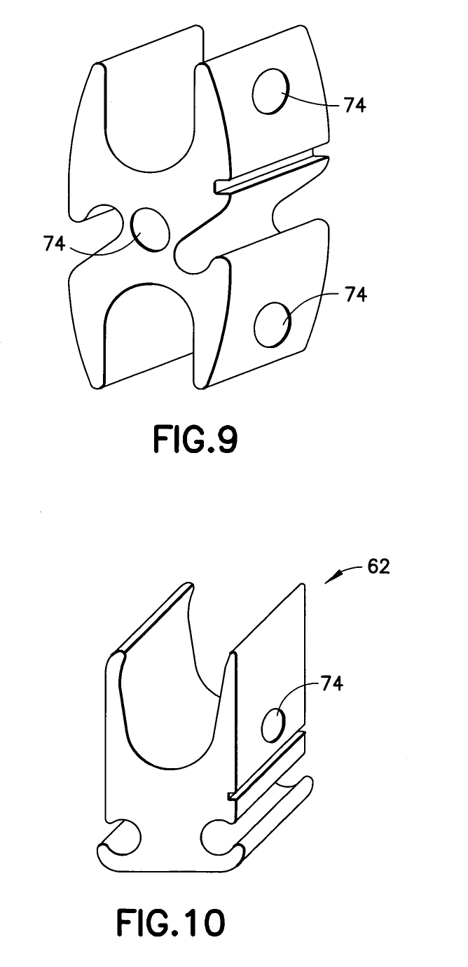

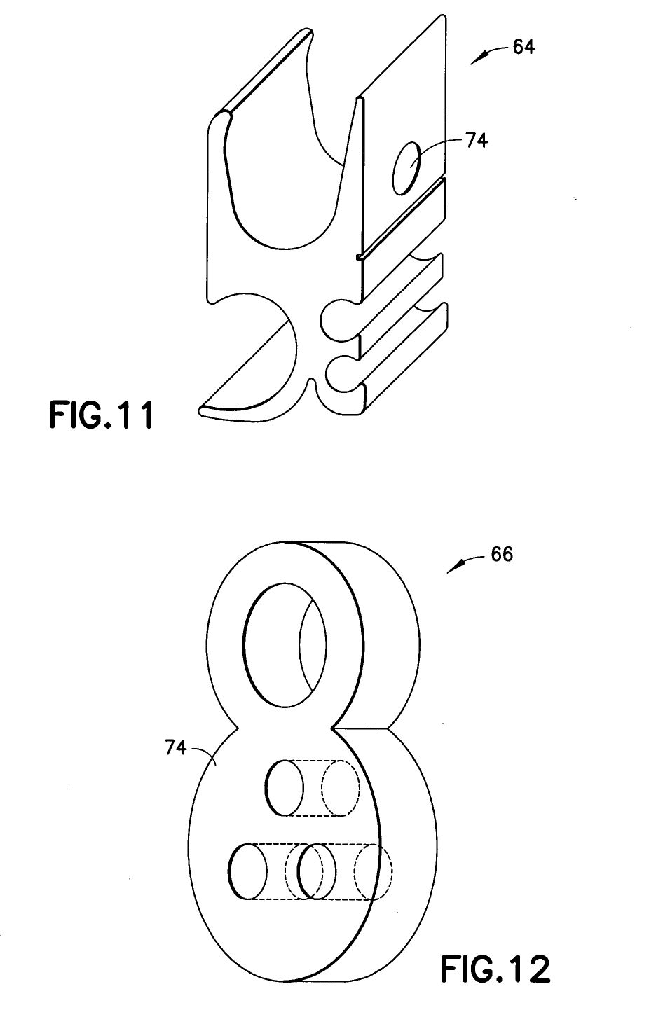

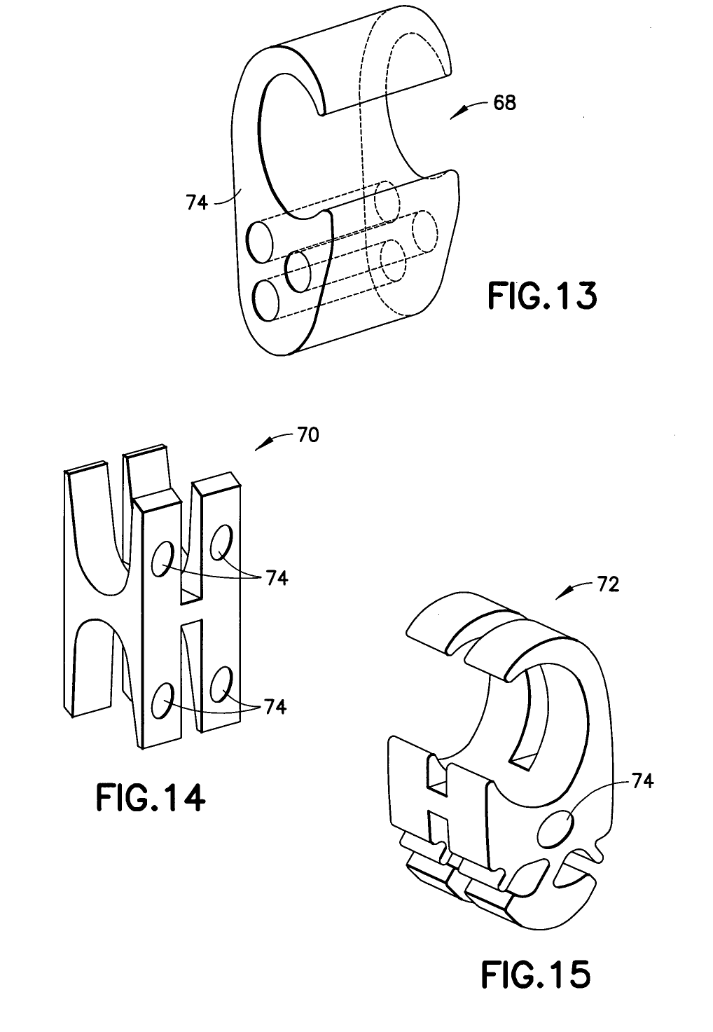

FIGS. 9-15 show other alternate embodiments of compression electrical connectors 60-72 having connector performance indicating sections 74 as described above. Similar electrical connectors are described in U.S. Pat. Nos. 6,525,270, 6,538,204, 6,552,271, 5,036,164, 5,103,068, 5,162,615, 6,818,830 and 6,846,989 which are hereby incorporated by reference in their entireties. In alternate embodiments, any suitable size or shape of compression electrical connectors could be provided. The above-mentioned patents are merely cited for example. In alternate embodiments, the connector performance indicating sections could have any suitable size, shape, location and number on an electrical connector.

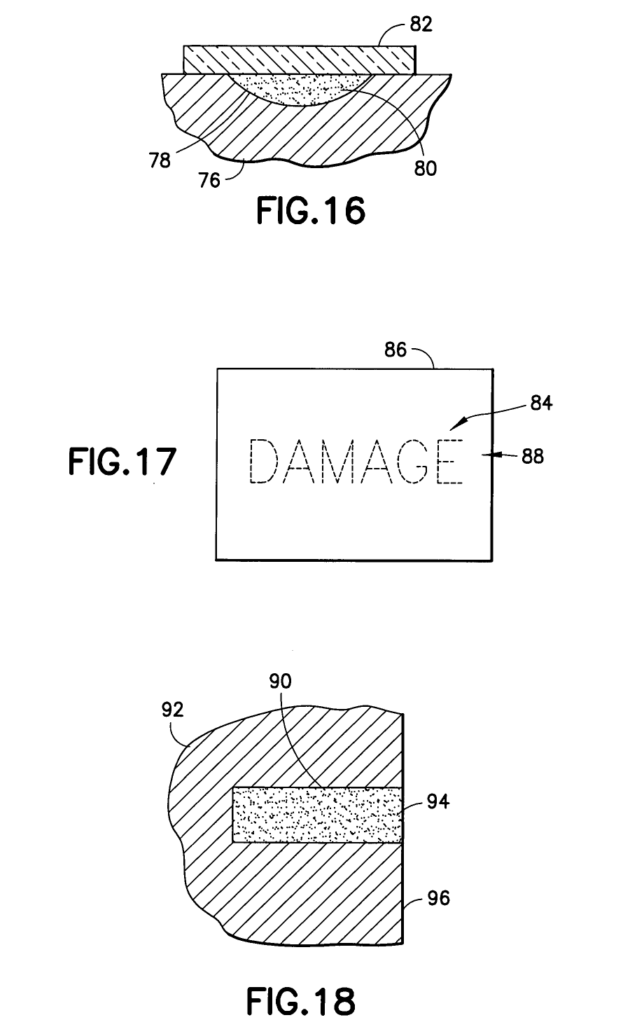

FIG. 16 is a partial cross sectional view showing one type of method of providing a heat shield for a connector performance indicating section. As noted above, the thermal shielding could shield the temperature sensitive indicator material from sources of heat that are not generated by a corresponding electrical connector. In this embodiment, the frame 76 of a connector has a recess 78 which receives the color changing temperature sensitive material 80. A thermal insulator 82 is attached to the frame to cover the material 80. The insulator 82 is preferably transparent such that the user can view the color of the material 80. The insulator 82 could be attached to the frame by any suitable method including, for example, adhesive or a fastener.

Referring also to FIG. 17, in one type of embodiment the connector performance indicating section 84 could be provided as a label or sticker 86. The section 84 could comprise indicium or writing 88 which is not visible to the user under normal operating conditions, but could change color at a predetermined temperature to appear visible to the user. Any suitable type of indicium could be provided.

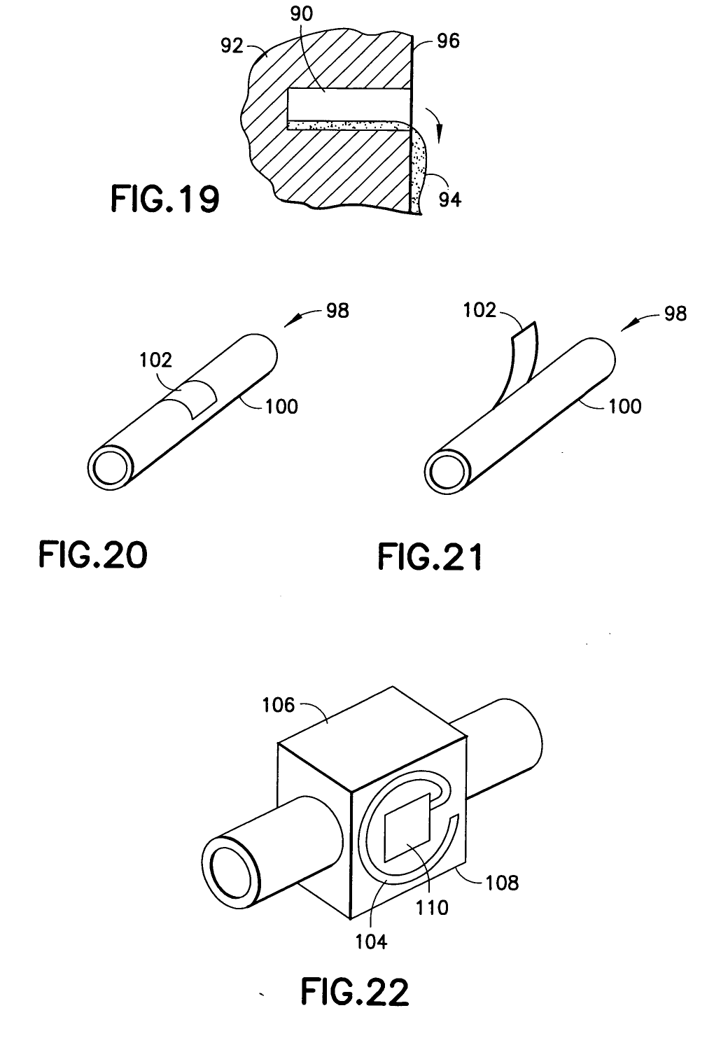

FIG. 18 illustrate another embodiment of the present invention. In this embodiment the connector performance indicating section comprises a recess 90 in the frame 92 of the connector, and a marker material 94 located in the recess 90. As noted above, the present invention could also be used by mixing a temperature sensitive indicator material, or even a non-temperature sensitive indicator material which is merely colored, with a melt material that melts at a predetermined temperature. Thus, the marker material does not need to be color changeable. The marker material 94 would be solid or otherwise prevented from flowing during normal operating conditions of the electrical connector. However, as shown in FIG. 19, if the connector experiences an over-temperature condition, the material 94 can flow out of the recess 90 along a side 96 of the frame to thereby mark the frame for a user to identify that an over-temperature condition has occurred.

FIG. 20 illustrates another embodiment of the present invention. In this embodiment the electrical connector 98 has a frame 100 and a connector performance indicating section 102. The connector performance indicating section comprises a shape memory alloy material, such as Nitinol for example. FIG. 20 shows the connector performance indicating section before an over-temperature condition. FIG. 21 shows the connector 98 after an over-temperature connection has occurred. The shape memory material can automatically change shape when the connector reaches a predetermined temperature to thereby signal occurrence of an over-temperature condition having been experienced by the connector.

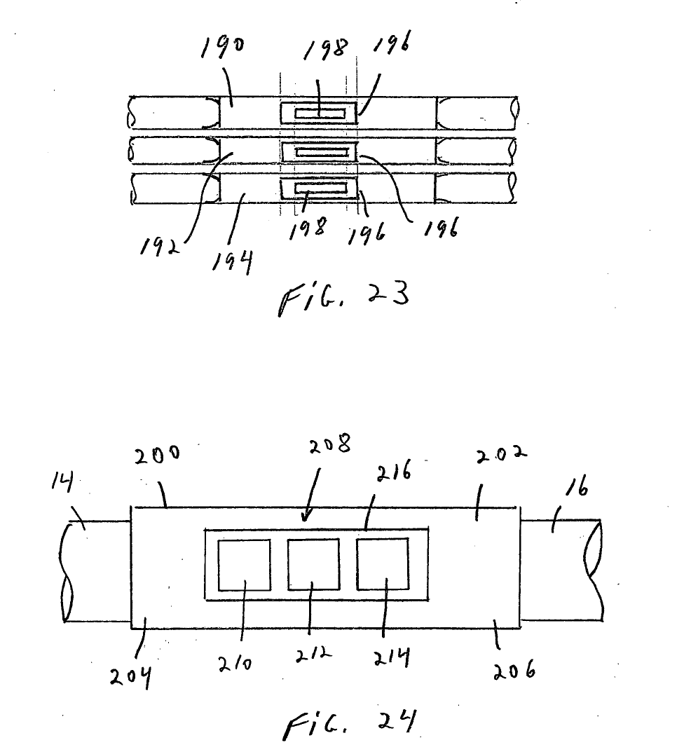

Referring also to FIG. 22, the present invention could comprise a Radio-Frequency Identification (RFID) tag 104 attached to a connector 106. In general, a RFID tag could be positioned on the connector in such a way that the antenna 108 and chip 110 are not destroyed by crimping. The RFID tag could function as the performance indicator attached to the crimpable connector. Similar to the paint/sticker embodiments described above, the RFID tag can transmit heat readings or an over-temperature occurrence.

FIG. 23 shows another embodiment. In this embodiment three connectors 190, 192, 194 are grouped together next to each other. Each connector has a label 196 affixed to it with a temperature color change material 198. The labels are located in close proximity to each other. Individually, the colors of the labels have no significance. However, grouped together, a connector operating at a different color than the other connectors in the same group or set could be used to indicate poor performance and therefore suggest additional investigation.

FIG. 24 shows another embodiment. In this embodiment the connector 200 comprises a connection member 202 with two connection sections 204, 206 for coupling two conductors 14, 16 to each other. The connector 200 also comprises a connector performance indicating section 208 comprising multiple colored items 210, 212, 214. In alternate embodiments more or less than three colored items could be provided. In this embodiment the three colored items are provided on a single label 216 which is affixed to the connection member 202. The colored items 210, 212, 214 have the same color in normal conditions. The first item 210 is not adapted to change color based upon temperature. The second item 212 is adapted to change color at a first predetermined temperature. The third item 214 is adapted to change color at a second higher predetermined temperature. The items 210, 212, 214 are grouped together such that their colors can be compared to each other. If the second or third items 212, 214 have different colors from the first item 210 this can be easily seen because they are grouped together. Thus, it is relatively easy for a user to observe an over-temperature condition by merely seeing if the items have different colors relative to each other.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. An electrical connector comprising:
a main section comprising a first connection section adapted to connect to a first electrical conductor and a second connection section adapted to connect to a second electrical conductor, wherein the main section is adapted to electrical connect the first electrical conductor to the second electrical conductor; and
a connector performance indicating section connected to a portion of the main section, wherein the connector performance indicating section comprises a temperature sensitive chemical indicator adapted to signal and permanently record a temperature of the portion of the main section above a predetermined temperature.

2. An electrical connector as in claim 1 wherein the first section comprises a compressible section which is sized and shaped to be compressed onto the first electrical conductor.

3. An electrical connector as in claim 2 wherein the connector performance indicating section is located on the compressible section.

4. An electrical connector as in claim 1 wherein the connector performance indicating section comprises paint.

5. An electrical connector as in claim 1 wherein the connector performance indicating section comprises a label.

6. An electrical connector as in claim 1 wherein the connector performance indicating section comprises multiple temperature indicators.

7. An electrical connector as in claim 6 wherein at least two of the temperature indicators are adapted to respectively signal occurrence of two different temperatures.

8. An electrical connector as in claim 1 wherein the chemical indicator comprises a phase change temperature indicator.

9. An electrical connector as in claim 1 further comprising a thermal insulator located at an exterior side of the chemical indicator.

10. An electrical connector as in claim 1 wherein the connector performance indicating section comprises an entirely non-electrical temperature signaling system.

11. An electrical connector comprising:
a compressible connection section which is sized and shaped to be compressed onto an electrical conductor; and
a visual indicium temperature sensitive indicator thermally coupled to the compressible connection section, wherein the temperature sensitive indicator is adapted to signal and permanently record occurrence of a temperature at the temperature sensitive indicator above a predetermined temperature.

12. An electrical connector as in claim 11 wherein the compressible section comprises a tube shaped section.

13. An electrical connector as in claim 11 wherein the compressible section comprises a channel shaped section.

14. An electrical connector as in claim 11 wherein the compressible section comprises a conductor receiving through-hole.

15. An electrical connector as in claim 11 wherein the compressible section comprises a plurality of conductor receiving channels.

16. An electrical connector as in claim 11 wherein the visual indicium temperature sensitive indicator comprises a chemical temperature sensitive material.

17. An electrical connector as in claim 11 wherein the visual indicium temperature sensitive indicator comprises a phase change temperature indicator.

18. An electrical connector as in claim 11 wherein the visual indicium temperature sensitive indicator comprises a color change temperature indicator.

19. An electrical connector as in claim 11 wherein the visual indicium temperature sensitive indicator comprises a flowable material adapted to flow on the connector at the predetermined temperature.

20. An electrical connector as in claim 11 wherein the visual indicium temperature sensitive indicator comprises a shape memory material.

21. An electrical connector comprising:
a compressible connection section which is sized and shaped to be compressed onto an electrical conductor; and
a non-electrical temperature sensitive indicator thermally coupled to the compressible connection section, wherein the temperature sensitive indicator is adapted to signal and permanently record occurrence of a temperature at the temperature sensitive indicator above a predetermined temperature.

22. A method of manufacturing an electrical connector comprising:
providing an electrical connector member; and
thermally coupling a temperature sensitive indicator to the electrical connector member, wherein the temperature sensitive indicator is adapted to permanently signal by visual indicium occurrence of a temperature at the temperature sensitive indicator above a predetermined temperature.

23. An electrical connector as in claim 1 wherein the connector performance indicating section comprises a plurality of temperature sensitive chemical indicators adapted to signal and permanently record a temperature of the portion of the main section above a predetermined temperature.

24. An electrical connector as in claim 1 wherein the connector performance indicating section comprises the temperature sensitive chemical indicator having a first color and a color item proximate the temperature sensitive chemical indicator having a same color, and wherein the temperature sensitive chemical indicator is adapted to change color at the predetermined temperature, and the color item does not change color at the predetermined temperature.

25. A group of electrical connectors comprising at least two electrical connectors of claim 1, wherein the group of electrical connectors are arranged with their temperature sensitive chemical indicators located generally next to each other for viewing at a same time.
